(19) United States
(12) Patent Application Publication
(10) Pub. No.: US 2006/0242453 A1
(43) Pub. Date: Oct. 26, 2006

(54) System and method for managing hung cluster nodes

(75) Inventors: Ravi Kumar, Austin, TX (US); Peyman Najafirad, Austin, TX (US)

Correspondence Address: BAKER BOTTS, LLP, 910 LOUISIANA, HOUSTON, TX, 77002-4995, US

(73) Assignee: DELL PRODUCTS L.P., Round Rock, TX (US)

(21) Appl. No.: 11/113,759

(22) Filed: Apr. 25, 2005

(51) Int. Cl. G06F 11/00

(52) U.S. Cl. 714/4

(57) ABSTRACT

A method of enforcing active-active cluster input/output fencing through out-of-band management network for hung cluster nodes is disclosed. In accordance with one embodiment of the present disclosure, a method of resetting a cluster node in a shared storage system includes identifying the cluster node from a plurality of cluster nodes based on the cluster node failing to respond to a cluster service application. The method further includes propagating a reset signal to the cluster node using an out-of-band channel to perform a hardware reset of the cluster node.

### TECHNICAL FIELD

The present disclosure relates generally to information handling systems and, more particularly, to a system and method for managing hung cluster nodes.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

An enterprise system, such as a shared storage cluster, is one example of an information handling system. The storage cluster typically includes a plurality of interconnected servers that can access a plurality of storage devices. Because the devices and servers are all interconnected, each item in the cluster may be referred to as a cluster node.

Clusters generally use a software solution to manage and maintain the cluster services. One example of a solution is an Oracle™ Real Application Cluster solution. These solutions typically use agents or cluster daemons to aid in the management of the cluster. One of these daemons is a Cluster Ready Services (CRS).

The CRS is used to monitor the health of the cluster nodes. When a problem occurs with a cluster node such as an unstable node, the CRS may remove the cluster node from the quorum of available nodes and then attempt to reset the node using a reset signal along the communication bus.

However, the outcome of the reset signal is never tracked since the CRS monitor does not control the execution of the action. As such, the node may remain in an unstable condition, which can affect the operation of the cluster.

One attempt to prevent problems from spreading to the rest of the cluster is to implement input/output (I/O) fencing algorithms. Based on a software failure on a local or remote cluster system, the I/O fencing algorithm would “fence-off” the unstable node to prevent data from transferring across the node to avoid possible data corruption and potentially cluster failure.

### SUMMARY

In accordance with one embodiment of the present disclosure, a method of resetting a cluster node in a shared storage system includes identifying the cluster node from a plurality of cluster nodes based on the cluster node failing to respond to a cluster service application. The method further includes propagating a reset signal to the cluster node using an out-of-band channel to perform a hardware reset of the cluster node.

In a further embodiment, a system for resetting a hung cluster node using a hardware reset includes a plurality of cluster nodes forming a part of a network. The system further includes a cluster service application operable to monitor the health of each of the plurality of cluster nodes. The system further includes a quorum stored in the system, the quorum indicating an available status for each cluster node in the network. The cluster service application is operable to change the available status for a particular cluster node listed in the quorum if the particular cluster node fails to respond to the cluster service application. The system further includes a cluster agent operable to transmit the hardware reset to the particular cluster node using an out-of-band channel based on a change of available status of the particular cluster node in the quorum.

In accordance with a further embodiment of the present disclosure, a computer-readable medium having computer-executable instructions for resetting a cluster node in an information handling system is provided. The computer-executable instructions include instructions for identifying the cluster node from a plurality of cluster nodes based on the cluster node failing to respond to a cluster service application, and instructions for propagating a reset signal to the cluster node using an out-of-band channel to perform a hardware reset of the cluster node.

One technical advantage of some embodiments of the present disclosure is the ability to ensure that a cluster node has reset before returning the node to the quorum of cluster nodes. Because the hardware reset is able to determine whether the node is reset or rebooted, the node may not be returned to the quorum. Thus, the node will be completely reset prior to being returned to the cluster.

Another technical advantage of some embodiments of the present disclosure is the ability to prevent data loss. In addition to fencing algorithms that may prevent data from being sent to the problem cluster node, using a hardware reset may cause any data in the node to be sent to cache. Thus, any data stored in the node may be preserved until after the reset/reboot without any incidental loss of the data.

Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a block diagram showing a server, according to teachings of the present disclosure;

FIG. 2 is a block diagram showing an example embodiment of a shared storage system according to teachings of the present disclosure;

FIG. 3 is a block diagram of baseboard management controller (BMC) software components according to one embodiment of the present disclosure; and

FIG. 4 is a flowchart of one embodiment of a method of resetting a cluster node, such as a server, in a shared storage system, according to teachings of the present disclosure.

### DETAILED DESCRIPTION

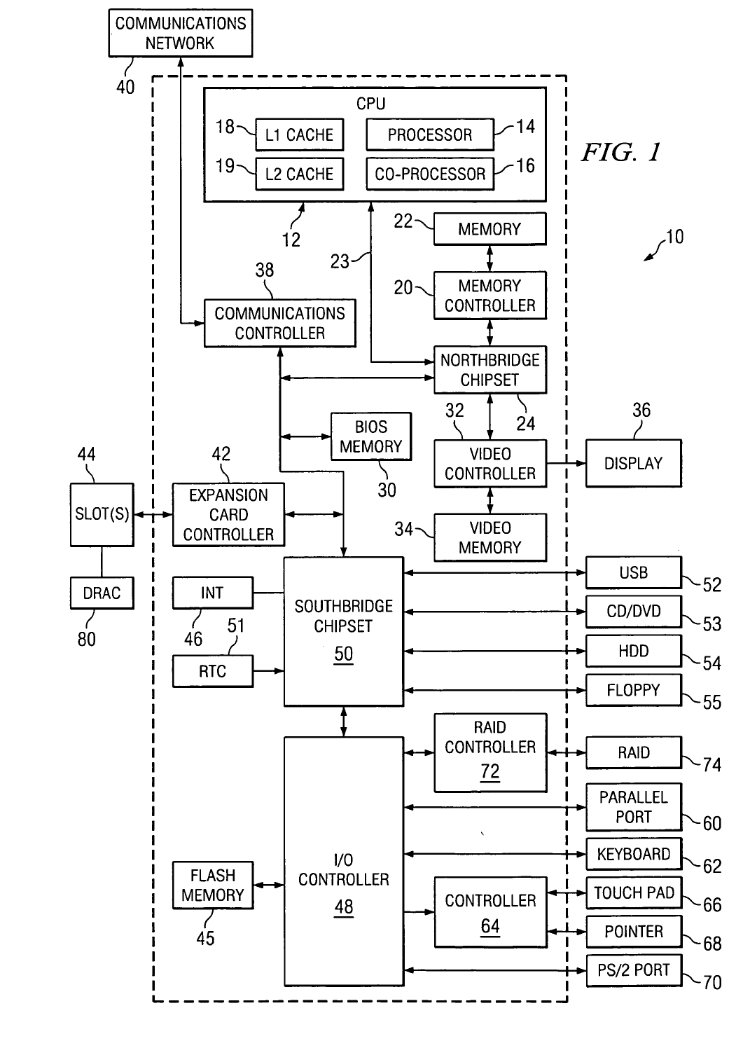

Preferred embodiments and their advantages are best understood by reference to FIGS. 1 through 4, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Referring first to FIG. 1, a block diagram of information handling system 10 is shown, according to teachings of the present disclosure. In one example embodiment, information handling system 10 is a server such as a Dell™ PowerEdge™ server. Information handling system 10 may include one or more microprocessors such as central processing unit (CPU) 12, for example. CPU 12 may include processor 14 for handling integer operations and coprocessor 16 for handling floating point operations. CPU 12 may be coupled to cache, such as L1 cache 18 and L2 cache 19, and a chipset, commonly referred to as Northbridge chipset 24, via a frontside bus 23. Northbridge chipset 24 may couple CPU 12 to memory 22 via memory controller 20. Main memory 22 of dynamic random access memory (DRAM) modules may be divided into one or more areas, such as system management mode (SMM) memory area (not expressly shown), for example.

Graphics controller 32 may be coupled to Northbridge chipset 24 and to video memory 34. Video memory 34 may be operable to store information to be displayed on one or more display panels 36. Display panel 36 may be an active matrix or passive matrix liquid crystal display (LCD), a cathode ray tube (CRT) display or other display technology. In selected applications, uses or instances, graphics controller 32 may also be coupled to an integrated display, such as in a portable information handling system implementation.

Northbridge chipset 24 may serve as a “bridge” between CPU bus 23 and the connected buses. Generally, when going from one bus to another bus, a bridge is needed to provide the translation or redirection to the correct bus. Typically, each bus uses its own set of protocols or rules to define the transfer of data or information along the bus, commonly referred to as the bus architecture. To prevent communication problem from arising between buses, chipsets such as Northbridge chipset 24 and Southbridge chipset 50, are able to translate and coordinate the exchange of information between the various buses and/or devices that communicate through their respective bridge.

Basic input/output system (BIOS) memory 30 may also be coupled to PCI bus connecting to Southbridge chipset 50. FLASH memory or other reprogrammable, nonvolatile memory may be used as BIOS memory 30. A BIOS program (not expressly shown) is typically stored in BIOS memory 30; The BIOS program may include software which facilitates interaction with and between information handling system 10 devices such as a keyboard 62, a mouse such as touch pad 66 or pointer 68, or one or more I/O devices, for example. BIOS memory 30 may also store system code (note expressly shown) operable to control a plurality of basic information handling system 10 operations.

Communication controller 38 may enable information handling system 10 to communicate with communication network 40, e.g., an Ethernet network. Communication network 40 may include a local area network (LAN), wide area network (WAN), Internet, Intranet, wireless broadband or the like. Communication controller 38 may be employed to form a network interface for communicating with other information handling systems (not expressly shown) coupled to communication network 40.

In certain information handling system embodiments, expansion card controller 42 may also be included and may be coupled to a PCI bus. Expansion card controller 42 may be coupled to a plurality of information handling system expansion slots 44. Expansion slots 44 may be configured to receive one or more computer components such as an expansion card (e.g., modems, fax cards, communications cards, and other input/output (I/O) devices).

Southbridge chipset 50, also called bus interface controller or expansion bus controller may couple PCI bus 25 to an expansion bus. In one embodiment, expansion bus may be configured as an Industry Standard Architecture (“ISA”) bus. Other buses, for example, a Peripheral Component Interconnect (“PCI”) bus, may also be used.

Interrupt request generator 46 may also be coupled to Southbridge chipset 50. Interrupt request generator 46 may be operable to issue an interrupt service request over a predetermined interrupt request line in response to receipt of a request to issue interrupt instruction from CPU 12. Southbridge chipset 40 may interface to one or more universal serial bus (USB) ports 52, CD-ROM (compact disk-read only memory) or digital versatile disk (DVD) drive 53, an integrated drive electronics (IDE) hard drive device (HDD) 54 and/or a floppy disk drive (FDD) 55, for example. In one example embodiment, Southbridge chipset 50 interfaces with HDD 54 via an IDE bus (not expressly shown). Other disk drive devices (not expressly shown) which may be interfaced to Southbridge chipset 50 may include a removable hard drive, a zip drive, a CD-RW (compact disk-read/write) drive, and/or a CD-DVD (compact disk-digital versatile disk) drive, for example.

Real-time clock (RTC) 51 may also be coupled to Southbridge chipset 50. Inclusion of RTC 51 may permit timed events or alarms to be activated in the information handling system 10. Real-time clock 51 may be programmed to generate an alarm signal at a predetermined time as well as to perform other operations.

I/O controller 48, often referred to as a super I/O controller, may also be coupled to Southbridge chipset 50. I/O controller 48 may interface to one or more parallel port 60, keyboard 62, device controller 64 operable to drive and interface with touch pad 66, pointer 68, and/or PS/2 Port 70, for example. FLASH memory or other nonvolatile memory may be used with I/O controller 48.

RAID 74 may also couple with I/O controller using interface RAID controller 72. In other embodiments, RAID 74 may couple directly to the motherboard (not expressly shown) using a RAID-on-chip circuit (not expressly shown) formed on the motherboard.

Generally, chipsets 24 and 50 may further include decode registers to coordinate the transfer of information between CPU 12 and a respective data bus and/or device. Because the number of decode registers available to chipset 24 or 50 may be limited, chipset 24 and/or 50 may increase the number or I/O decode ranges using system management interrupts (SMI) traps.

Information handling system 10 may also include a remote access card such as Dell™ remote access card (DRAC) 80. Although the remote access card is shown, information handling system may include any hardware device that allows for communications with information handling system 10. In some embodiments, communications using the hardware device with information handling system 10 is performed using an out-of-band channel. For example, in a shared storage system, several cluster nodes may be in communications using a variety of channels to exchange data. The out-of-band channel would be any communication channel that is not being used for data exchange.

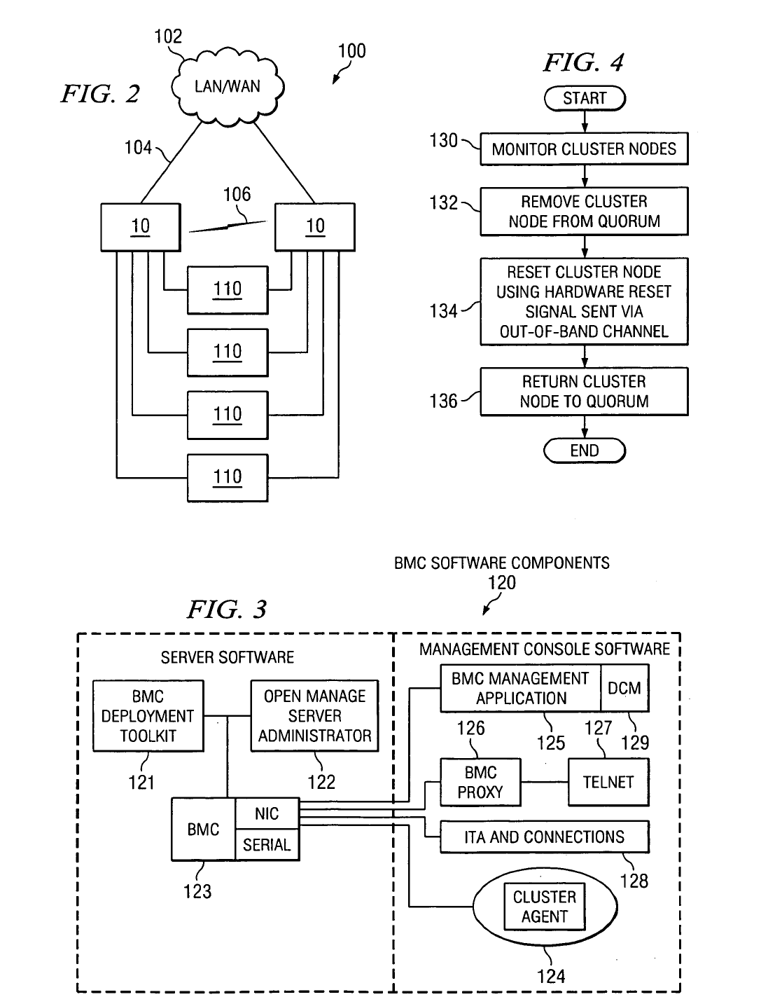

FIG. 2 is a block diagram showing an example embodiment of a shared storage system or cluster 100 including information handling systems 10 (e.g., servers) that are communicatively coupled to wide area network (WAN)/local area network (LAN) 102 via connections 104 is shown. As such, WAN/LAN 102 may also be used to access storage device units 110 via information handling systems 10. Thus, storage device units 110 are communicatively coupled to information handling systems 10. Generally, storage device units 110 include hard disk drives or any other devices which store data.

In some embodiments, shared storage cluster 100 may include a plurality of information handling systems 10 may be collectively linked together via connections 106, wherein each information handling system 10 is a node (or “cluster node”) in cluster 100. Generally, connections 106 couple with a network interface card (shown below in more detail) that may include a remote access card. Each cluster node may include a variety of communications channels including channels considered to be out-of-band channels.

Shared storage cluster 100 is an example of an active-active cluster. Typically, shared storage cluster 100 includes an available cluster solution, which may include agents or daemons that monitor the health of devices in cluster 100. One such daemon includes a cluster ready service (CRS) application (not expressly shown) that is used to monitor the health of cluster nodes such as information handling systems 10.

In monitoring the health of the cluster nodes, the CRS application generally tracks or lists the health of the node in a list or file. The list or file, commonly referred to as a quorum, indicates, among other indications, the availability of each cluster node. For example, the quorum may include an availability field in which a byte of memory may indicate whether each cluster node has responded to a periodic status check performed by the CRS application. If a particular node does not respond to the periodic status check, that node may be removed from the quorum by changing the value of the byte in the availability field for that node to indicate that the node is not available for use.

FIG. 3 illustrates a block diagram of baseboard management controller (BMC) software components 120, in accordance with an embodiment of the disclosure. BMC software components 120 are typically stored in memory, such as memory 22 for example, and executed by a processor, such as processor 14 or co-processor 16 (see FIG. 1), for example.

BMC software components 120 may include server software and management console software. The server software generally provides for deployment and administration for the configuration of the server. As such, BMC deployment toolkit software 121 typically includes the pre-operating system configuration and setting for users, alerts and network and serial ports. Administration software such as OpenManager Server Administration software 122 generally includes post-operating system configurations as well as BMC in-band monitoring and control.

The server software may also include BMC software 123 able to interact with network interface cards (NIC) and serial communications. Typically, the NIC is used to interface with the management console software for performing hardware operations within shared storage system 100.

Management console software generally includes BMC management application 125 that provides command line interface with the server, allows for viewing the server log and sensors, and/or controls server power and reset. BMC management application 125 typically includes distributed cluster manager (DCM) 129 that generally includes a CRS daemon, which may be used to monitor cluster nodes.

Additionally, management console software may include a BMC Proxy agent 126 coupled with a Telnet agent 127 that may allow for access to server text console and allow for interaction with the server basic input/output system (BIOS) and the operating system text console, generally during remote computing on the Internet. Further, management console software may include an information technology assistant (ITA) and an operations agent 128 to allow for alerts to be received from the BMC.

In addition to these software agents, management console software may include a cluster agent 124. Cluster agent 124 may monitor the availability of cluster nodes in the cluster via the list or quorum. In one embodiment, cluster agent 124 may cause a hardware reset to be sent to the unavailable node via an out-of-band channel. The out-of-band channel may include a communications link that is not utilized for the transfer of information within shared storage system 100.

FIG. 4 is flowchart of a method of resetting a cluster node, such as information handling system 10, in shared storage system 100, according to an embodiment of the disclosure. At step 130, a cluster service application that is commonly included as part of distributed cluster manager 129 monitors the health of the cluster nodes. As discussed above, in some embodiments, the cluster service application is a cluster ready service (CRS) application. The CRS application may send a query to each cluster node to determine whether that node is communicating properly. This query or check may be performed at periodic or pre-determined intervals.

If a node does not respond (e.g., within a pre-determined time period) or is otherwise determined to be malfunctioning, the CRS application may remove the node from the quorum, as shown in block 132. In some embodiments, once a node is removed from the quorum, an input/output (I/O) fencing algorithm may be initiated to prevent data from being sent to and/or received by the removed node.

In response to the cluster node being removed from the quorum, cluster agent 124 may initiate a hardware reset of the removed cluster node as shown at block 134. In one example embodiment, cluster agent 124 causes a hardware reset to be sent to the cluster node using a remote access controller, such as Dells remote access card 80, for example. However, in other embodiments, cluster agent 124 may use any device to cause the hardware reset of the problem cluster node.

In some embodiments, the hardware reset may be sent along an out-of-band channel to prevent interference with other communications. In addition, because the reset is a hardware reset, the remote access controller may determine whether the cluster node has reset. In some instances, the remote access controller waits for the cluster node to reset and respond back to the remote access controller with a return-signal. Typically, the hardware reset signal will result in the cluster node (e.g., server) being rebooted and thus causing a return signal indicating the node is reset to be sent back to the cluster agent. Once the return signal is received, the remote access controller may resume monitoring the quorum to ensure the cluster node is active again.

Once the cluster node is reset, the CRS application may send another query to the reset cluster node, typically during a periodic check of one, some or all of the nodes in the cluster 100. If the reset cluster node responds that the cluster is active, the CRS application may place the cluster node back into the quorum, as shown at block 136.

Although the disclosed embodiments have been described in detail, it should be understood that various changes, substitutions and alterations can be made to the embodiments without departing from their spirit and scope.

What is claimed is:

1. A method of resetting a cluster node in a shared storage system, the method comprising:
identifying the cluster node from a plurality of cluster nodes based on the cluster node failing to respond to a cluster service application; and
propagating a reset signal to the cluster node using an out-of-band channel to perform a hardware reset of the cluster node.

2. The method of claim 1, further comprising isolating the cluster node from the plurality of cluster nodes such that the cluster nodes is prevented from transferring data within the shared storage system.

3. The method of claim 1, further comprising applying an input/output (I/O) fencing agent to block data attempting to access the cluster node.

4. The method of claim 1, wherein the isolation of the cluster node comprises removing the cluster node from a quorum of cluster nodes.

5. The method of claim 4, further comprising:
determining that the cluster node is responding to the cluster service application; and
in response to determining that the cluster node is responding to the cluster service application, adding the cluster node back to the quorum of cluster nodes.

6. The method of claim 1, wherein propagating a reset signal to the cluster node using an out-of-band channel comprising propagating a reset signal to the cluster node using an out-of-band channel an out-of-band channel of a remote access card.

7. The method of claim 1, wherein the identification of the cluster node comprises monitoring the cluster node using the cluster service application at a pre-set interval.

8. The method of claim 1, wherein the cluster service application comprises a cluster ready services application.

9. A system for resetting a hung cluster node using a hardware reset, comprising:
a plurality of cluster nodes forming a part of a network;
a cluster service application operable to monitor the health of each of the plurality of cluster nodes;
a quorum stored in the system, the quorum indicating an available status for each of the plurality of cluster nodes;
wherein the cluster service application is operable to change the available status for a particular cluster node listed in the quorum if the particular cluster node fails to respond to the cluster service application; and
a cluster agent operable to transmit the hardware reset to the particular cluster node using an out-of-band channel based on a change of available status of the particular cluster node in the quorum.

10. The system of claim 9, wherein the network comprises a shared storage network.

11. The system of claim 9, further comprising a remote access card operable to access the particular cluster node and transmit the hardware reset to the particular cluster node.

12. The system of claim 9, wherein the cluster service application is operable to remove the particular cluster node from the quorum if the particular cluster node fails to respond to the cluster service application.

13. The system of claim 9, wherein the particular cluster node comprises a server.

14. The system of claim 9, further comprising an input/output fencing agent operable to block data attempting to access the particular cluster node.

15. A computer-readable medium having computer-executable instructions for resetting a cluster node in an information handling system, comprising:
instructions for identifying the cluster node from a plurality of cluster nodes based on the cluster node failing to respond to a cluster service application; and
instructions for propagating a reset signal to the cluster node using an out-of-band channel to perform a hardware reset of the cluster node.

16. The computer-readable medium of claim 15, further comprising instructions for isolating the cluster node from the plurality of cluster nodes such that the cluster node is prevented from transferring data within the shared storage system.

17. The computer-readable medium of claim 15, further comprising instructions for applying an input/output (I/O) fencing agent to block data attempting to access the cluster node.

18. The computer-readable medium of claim 15, further comprising:
instructions for determining that the cluster node is responding to the cluster service application; and
instructions for adding the cluster node back to the quorum of cluster nodes in response to a determination that the cluster node is responding to the cluster service application.

19. The computer-readable medium of claim 15, wherein the instructions for identifying the cluster node comprise instructions for monitoring the cluster node at pre-set intervals using the cluster service application.

20. The computer-readable medium of claim 15, wherein the instructions for propagating a reset signal to the cluster node using an out-of-band channel comprise instructions for propagating a reset signal to the cluster node using an out-of-band channel of a remote access card.
